(19) United States
(12) Patent Application Publication
(10) Pub. No.: US 2005/0238757 A1
(43) Pub. Date: Oct. 27, 2005

(54) Method and apparatus for assisting ejection from an injection molding machine using active material elements

(76) Inventors: Joachim Johannes Niewels, Thornton (CA); Zbigniew Romanski, Mississauga (CA)

Correspondence Address: KATTEN MUCHIN ROSENMAN LLP, 525 WEST MONROE STREET, CHICAGO, IL, 60661-3693, US

(21) Appl. No.: 10/830,435

(22) Filed: Apr. 23, 2004

(51) Int. Cl. B29C 45/40

(52) U.S. Cl. 425/556; 264/335; 264/40.5

(57) ABSTRACT

Method and apparatus for assisting the ejection of molded parts from a mold having a first surface and a second surface include an active material actuator configured to be disposed between the first surface and a second surface. The active material actuator is configured to provide an expansive force between the first surface and the second surface in response to actuation signals, pushing the surfaces apart. Transmission structure is coupled to the active material actuator and is configured to transmit the actuation signals. The molded part may be ejected upon initiation of the actuation signal, or upon withdrawal of the actuation signal.

### BACKGROUND OF THE INVENTION

1. Field of the Invention

The present invention relates to a method and apparatus in which active material elements are used in injection molding machine equipment (e.g., mold assemblies), in order to aid in ejecting the molded part from the mold core. “Active materials” are a family of shape altering materials such as piezoactuators, piezoceramics, electrostrictors, magnetostrictors, shape memory alloys, and the like. In the present invention, they are used to initiate the ejection of the molded part thereby improving the efficiency of the molding cycle. The active material elements may be used as sensors and/or actuators.

2. Related Art

Active materials are characterized as transducers that can convert one form of energy to another. For example, a piezoactuator (or motor) converts input electrical energy to mechanical energy causing a dimensional change in the element, whereas a piezo sensor (or generator) converts mechanical energy—a change in the dimensional shape of the element—into electrical energy. One example of a piezoceramic transducer is shown in U.S. Pat. No. 5,237,238 to Berghaus. One supplier of piezo actuators is Marco Systemanalyse und Entwicklung GmbH, Hans-Böckler-Str. 2, D-85221 Dachau, Germany, and their advertising literature and website illustrate such devices. Typically an application of 1,000 volt potential to a piezoceramic insert will cause it to “grow” approximately 0.0015″/inch (0.15%) in thickness. Another supplier, Mide Technology Corporation of Medford, Me., has a variety of active materials including magnetostrictors and shape memory alloys, and their advertising literature and website illustrate such devices, including material specifications and other published details.

The ejection of a molded parts from the core that formed its interior is typically accomplished in the injection molding art by mechanical means (e.g., pins, sleeves, or rings) pushing the part off of the core. More recently, air ejection has been employed for certain types of parts like containers, cups, etc., which parts form a natural receptacle into which pressurized air can be fed to cause the freshly molded part to be literally blown off of the core.

U.S. Pat. No. 4,660,801 to Schad is an example of such an air ejection mechanism. This patent also discloses providing a sleeve around the core tip to close the air vent during molding, thereby preventing entry of the molding material into the vent channel. Also disclosed in this patent is using the air pressure to (i) cause the sleeve to initially push the part away from the core for a short distance as the vent is opened by such movement, and (ii) then allowing the pressurized air to escape from the opened vent to complete the ejection action.

It is also known in the art to employ ejector boosters as part of the ejection mechanism, whereby fluid cylinders supplement the ejection mechanism for an initial part of the ejector stroke, to provide additional ejection force to break the part loose from the core at the beginning of the ejector stroke. A conventional ejection mechanism is used thereafter to complete the ejection stroke.

However, even with the advances in air ejection of parts, it is desirable to eject molded parts with greater speed, accuracy, and precision.

### SUMMARY OF THE INVENTION

It is an advantage of the present invention to provide injection molding machine apparatus and method to overcome the problems noted above, and to provide an advantageous, efficient means for ejecting molded parts in an injection molding machine.

According to a first aspect of the present invention, structure and/or function are provided for separating a molded article from a mold portion. An active material actuator is configured to be disposed adjacent the mold portion, and is configured to change dimension when an electrical signal is applied thereto. Transmission structure is also configured to provide, in use, the electrical signal to said active material actuator to cause the molded article to separate from the mold portion.

According to a second aspect of the present invention, structure and/or function are provided for ejecting a molded article from a core of an injection mold having a core and a core plate. An active material actuator is configured to be disposed between the core and the core plate, and is configured to generate a force between the core and the core plate in response to actuation signals. Wiring structure is coupled to the active material actuator and configured to carry the actuation signals.

According to a third aspect of the present invention, structure and/or function are provided for an injection molding machine for molding a molded article between a first mold half and a second mold half. A piezo-electric actuator is configured to be disposed between the first mold half and the second mold half of the injection molding machine, and is configured to generate an expansive force between the first mold half and the molded article in response to a corresponding actuation signal. A transmission structure is configured, in use, to transmit the actuation signal to the piezo-electric actuator.

### BRIEF DESCRIPTION OF THE DRAWINGS

Exemplary embodiments of the presently preferred features of the present invention will now be described with reference to the accompanying drawings in which:

FIG. 1 is a sectional view of a typical mold core half prior to ejection;

FIG. 2 is a sectional view of the mold core half of FIG. 1 after initial ejection has occurred;

FIG. 3 is a sectional view of the mold core half of FIG. 1 after final ejection has occurred;

FIG. 4 is a sectional view of a core lock style preform molding stack incorporating an embodiment according to the present invention in the resin feeding position; and

FIG. 5 is a sectional view of a core lock style preform molding stack incorporating an embodiment according to the present invention in the core retraction (initial ejection) position.

### DETAILED DESCRIPTION OF THE PRESENTLY PREFERRED EXEMPLARY EMBODIMENTS

### 1. Introduction

The present invention will now be described with respect to several embodiments in which a plastic injection-molding machine for is supplied with one or more active material elements which serve to aid in ejecting molded parts from injection molds, and particularly from the injection mold cores. Other applications for such active material elements are discussed in the related applications titled (1) “Method and Apparatus for Countering Mold Deflection and Misalignment Using Active Material Elements”, (2) “Method and Apparatus for Providing Adjustable Hot Runner Assembly Seals and Tip Height Using Active Material Elements”, (3) “Method and Apparatus for Controlling a Vent Gap with Active Material Elements”, (4) “Method and Apparatus for Mold Component Locking Using Active Material Elements”, (5) “Methods and Apparatus for Vibrating Melt in an Injection Molding Machine Using Active Material Elements”, (6) “Method and Apparatus for Injection Compression Molding Using Active Material Elements”, and (7) “Control System for Utilizing Active Material Elements in a Molding System”, all of which are being filed concurrently with the present application.

None of the prior ejection approaches employs devices such as active material inserts to provide an initial ejection force, or to employ active material inserts in an arrangement in which the core is first retracted from the molded part instead of moving the part off of the core. In the following description, piezoceramic inserts are described as the preferred active material. However, other materials from the active material family, such as magnetostrictors and shape memory alloys could also be used in accordance with the present invention. A list of possible alternate active materials and their characteristics is set forth below in Table 1, and any of these active materials could be used in accordance with the present invention:

TABLE 1
Comparison of Active Materials

| | Temperature | Nonlinearity | Structural | Cost/Vol. | Technical |
|---|---|---|---|---|---|
| Material | Range (° C.) | (Hysteresis) | Integrity | ($/cm 3) | Maturity |
| Piezoceramic | −50-250 | 10% | Brittle | 200 | Commercial |
| PZT-5A | | | Ceramic | | |
| Piezo-single | — | <10% | Brittle | 32000 | Research |
| crystal TRS-A | | | Ceramic | | |
| Electrostrictor | 0-40 | Quadratic <1% | Brittle | 800 | Commercial |
| PMN | | | Ceramic | | |
| Magnetostrictor | −20-100 | 2% | Brittle | 400 | Research |
| Terfenol-D | | | | | |
| Shape Memory | Temp. | High | OK | 2 | Commercial |
| Alloy Nitinol | Controlled | | | | |
| Magn. Activated | <40 | High | OK | 200 | Preliminary |
| SMA NiMnGa | | | | | Research |
| Piezopolymer | −70-135 | >10% | Good | 15* | Commercial |
| PVDF | | | | | |

(information derived from www.mide.com)

### 2. The Structure of the First Embodiment

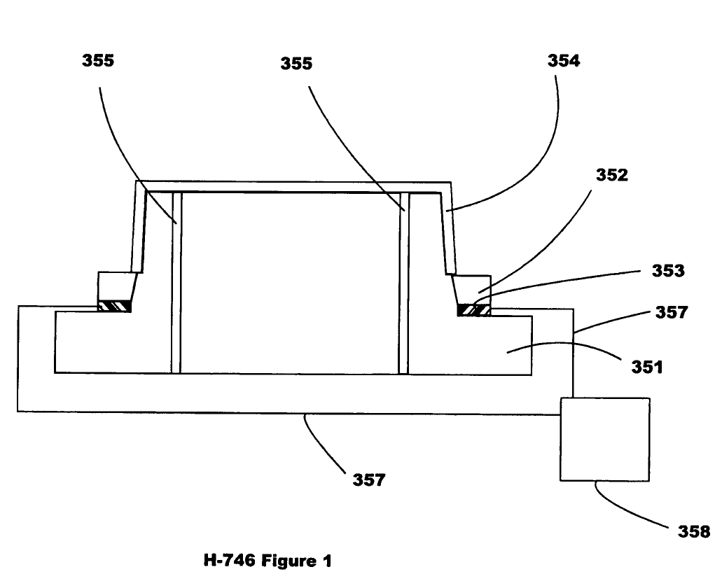

The first preferred embodiment of the present invention is shown in FIGS. 1-3, which depict the core half of an injection mold comprising a core 351, a stripper ring 352, and vent pins 355. A piezoceramic ejector ring 353 is provided between the core 351 and the stripper ring 352. In FIG. 1, a molded part 354 is shown freshly formed on the core, after the cavity half of the injection mold has been removed (not shown). After sufficient cooling to permit handling of the part without causing deformation, part 354 is ready to be ejected off of the core 351. Preferably, the piezoceramic ejector ring 353 comprises an annular disc of piezoceramic material, where the disc has a thickness of approximately 300 mm, in order to develop an initial ejection stroke of approximately 0.45 mm upon actuation.

The piezoceramic ejector ring 353 is connected to a controller 358 by wiring 357 that sends electrical signals to the ejector ring 353 to cause the ejector ring 353 to increase in height. Alternatively, the ejector ring may be substituted by multiple piezoceramic actuators placed around the periphery of the mold core 351. According to an alternative embodiment of the present invention, the stripper ring 352 may be eliminated, such that the molded part rests directly on the actuator 353.

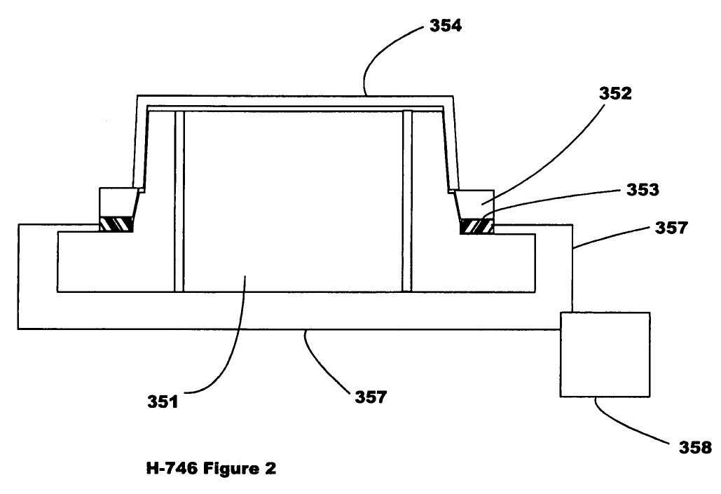

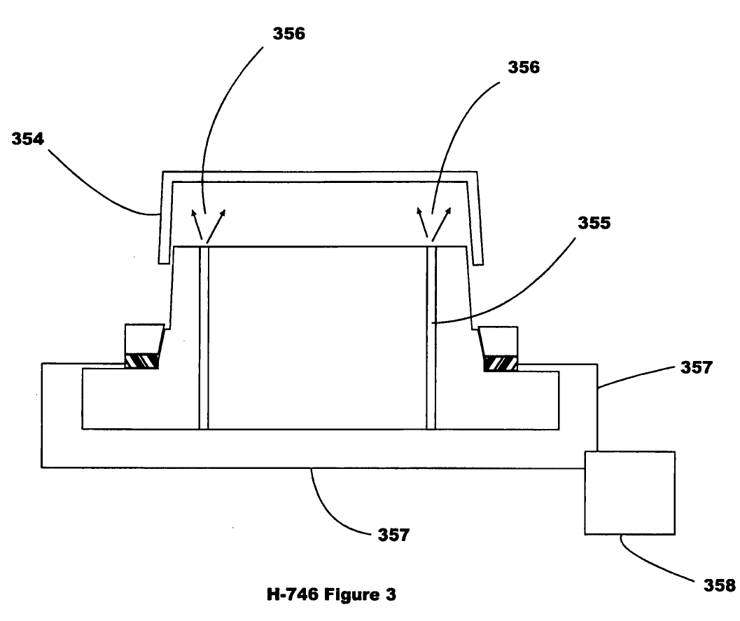

As shown in FIG. 2, regardless of the particular configuration of the ejector ring 353 and stripper ring 352, upon activation of the ejector ring 353 the molded part 354 is pushed upward off of the mold core by a distance at least equal to the increase in height of the ejector ring 353 when activated. For example, one or more layers of ejector ring 353 could lift the molded part 354 by 0.2 mm to 1.0 mm. This effect of pushing the molded part 354 off of the mold core 351 allows the supplemental use of compressed airflow 356 (FIG. 3) to be more efficient in removing the molded part 354 from the mold core 351. That is, the ejector ring 353 may initiate the stripping operation more rapidly than is possible with air ejection or other mechanical stripping techniques. This results in a time savings of which reduces the total cycle time. This can also eliminate the need for hydraulic circuits, valves, and associated hardware and controls, thereby greatly simplifying the molding machine, particularly machines of the Index type that use rotating turrets upon which to mount the core half of the mold.

### 3. The process of the First Embodiment

In operation, after the molded part has been formed on the core, FIG. 2 shows the initial ejection action of stripper ring 352 caused by the actuation of the piezoceramic ejector ring 353 beneath it. As the ring 353 is electrically energized, it grows in longitudinal thickness sufficient to push the stripper ring 352 upward, thereby moving the molded part 354 upward an initial distance off the core 351. Of course, the ejector ring 353 may be activated in timed stages and/or by different sections so as to lift the molded article at different times and/or at different locations and/or by different heights, or any combination of the above.

FIG. 3 shows the second stage of the ejection action in which a fluid flow 356, typically compressed air, is provided via vent pins 355. The fluid flow 356 causes the part 354 to complete its ejection motion and separate from the core 351.

### 4. The Structure of the Second Embodiment

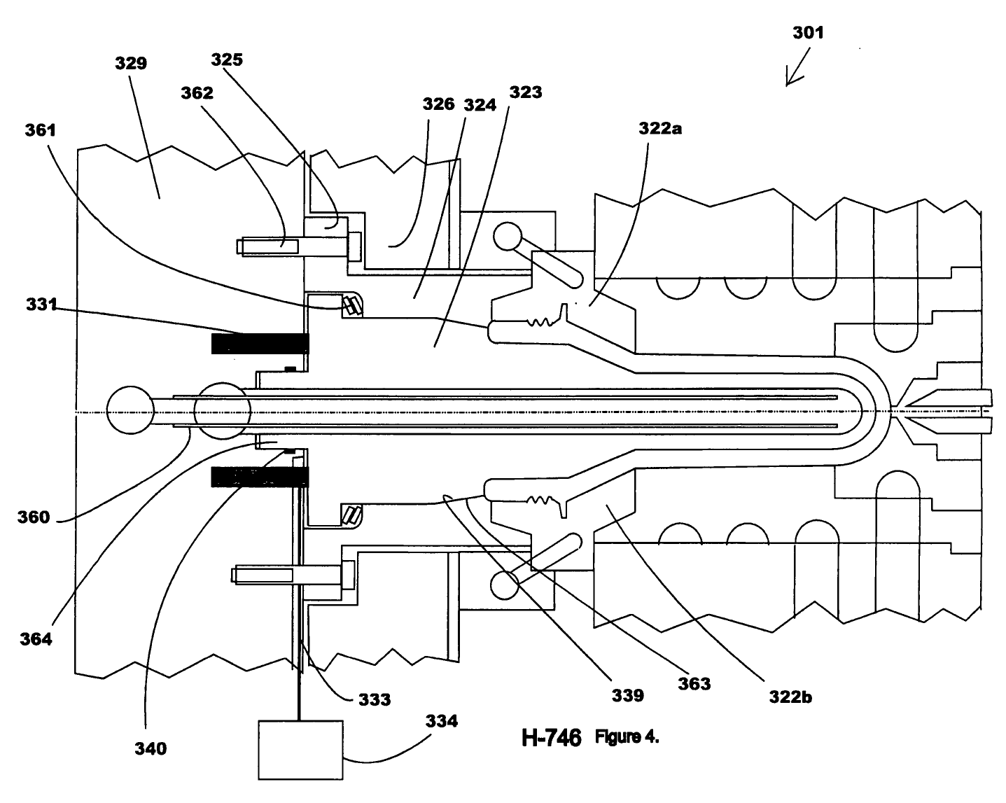

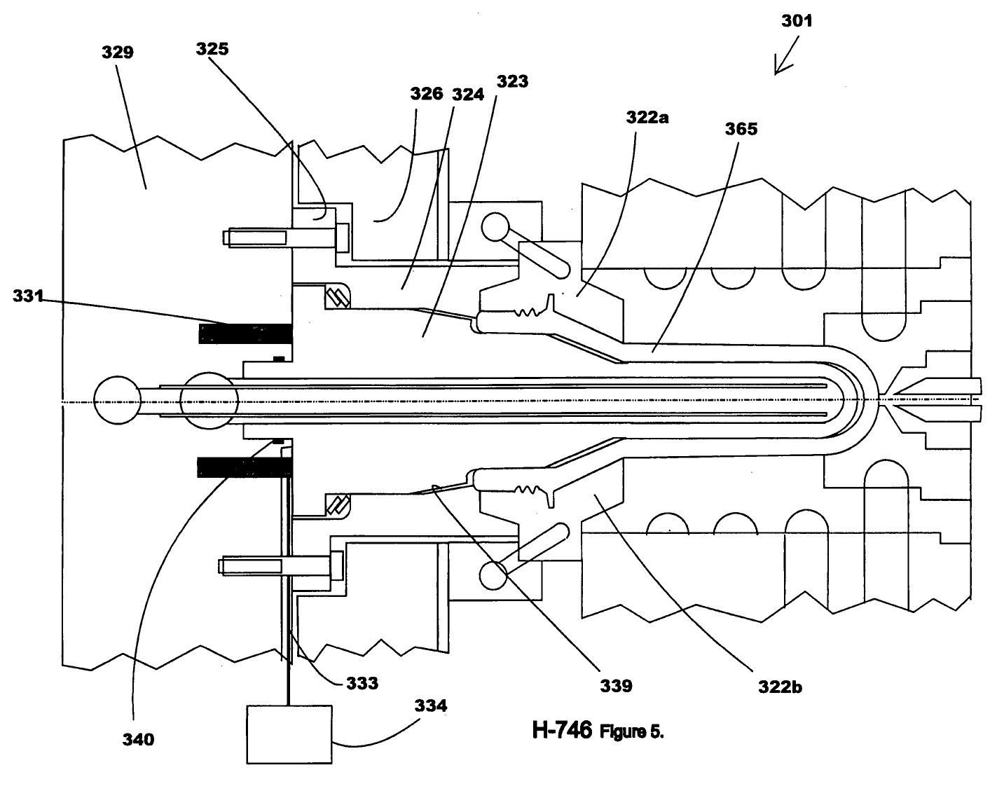

FIGS. 4-5 show a second embodiment of the present invention having an alternate mechanism for ejecting a molded article from a core. Preform molding stack 301 includes a core half that comprises a neck ring pair 322a and 322b, a lock ring 324, a core 323, a core cooling tube 360, a core seal 340, a core piezoceramic actuation sleeve 331, a power supply connection 333, a core spring set 361, and a lock ring bolts 362. Lock ring 324 has a flange 325 through which bolts 362 fasten the lock ring to the core plate 329. Core 323 is located in the core plate 329 by spigot 364 and is urged against the core plate 329 by a spring set 361 that comprises one or more Belleville or similar type spring washers.

The piezoceramic actuation sleeve 331 is positioned within the core plate, and when actuated it expands axially, thereby exerting a force against the base of the core 323, urging it away from the core plate 329, and compressing spring set 361. The core has a tapered alignment surface 339 that contacts complementary surface 363 on the inner surface of lock ring 324 such that when the actuation sleeve 331 is actuated, the core is held forward against said taper, as shown in FIG. 4. This actuated state corresponds to the molding position. Piezoceramic actuation sleeve 331 provides sufficient force holding the core 323 in this forward position to resist the injection pressure developed against the core molding surfaces during injection. The actuation sleeve 331 does not allow the core's taper 339 to separate from the corresponding lock ring taper 363, which would result in a risk of losing core stability and alignment. The piezoceramic actuation sleeve 331 may be provided in any of a variety of shapes and cross-sections. Preferably, the sleeve 331 has a high load capacity (up to 100 kN) and high force generator (up to 80 kN). Upon application of a signal, preferably from 0 to −1000 V DC, the sleeve 331 is actuated.

When the power supply connection 333 shuts off power to piezoceramic actuation sleeve 331, the sleeve returns to a non-actuated state in which it decreases in length. The non-actuated sleeve 331 no longer exerts a force against the core 323, and therefore the core spring set 361 is able to bias core 323 back against core plate 329. As the core 323 is biased back, it is withdrawn from within the molded part 365. The molded part 365 may then be quickly and efficiently removed from the molding stack 301 using conventional methods and/or apparatus.

The piezoceramic actuation sleeve 331 may comprise any of the devices manufactured by Marco Systemanalyse und Entwicklung GmbH. The piezo-electric actuator will receive an actuation signal through the power supply connection 333 and apply a corresponding force between the core plate 329 and the core 323. Note that more than one piezo-electric sensor may optionally be provided to sense pressure from any desired position in the preform molding stack 301. Likewise, more than one piezo-electric actuator may be provided, mounted serially or in tandem, in order to effect extended movement, angular movement, etc., of the core 323 with respect to the core plate 329.

The power supply connection 333 may be coupled to any desirable form of controller or processing circuitry 334 for reading the piezo-electric sensor signals and/or providing the actuating signals to the piezo-electric actuators. For example, one or more general-purpose computers, Application Specific Integrated Circuits (ASICs), Digital Signal Processors (DSPs), gate arrays, analog circuits, dedicated digital and/or analog processors, hard-wired circuits, etc., may control or sense the piezo-electric element 331 described herein. Instructions for controlling the one or more processors 334 may be stored in any desirable computer-readable medium and/or data structure, such floppy diskettes, hard drives, CD-ROMs, RAMs, EEPROMs, magnetic media, optical media, magneto-optical media, etc.

### 5. The Process of the Second Embodiment

In operation, upon completion of the injection and hold portions of the molding cycle and the initial cooling of the part sufficient to form a skin strong enough the allow ejection of the part without unacceptable distortion, the piezoceramic actuation sleeve 331 is deactivated. Deactivation of the piezo-electric actuation sleeve 331 causes the sleeve to retract, and thereby allows spring set 361 to propel the core 323 rearward toward the core plate 329, thereby causing an initial separation between the core 323 and the molded part 365, as illustrated in FIG. 5. Thereafter, the stripper plate 326 is actuated to advance the neck rings 322a and 322b to complete the ejection stroke in the conventional manner.

### CONCLUSION

Thus, what has been described is a method and apparatus for using active material elements in an injecting molding machine to effect useful improvements in the ejection of molded parts from an injection molding apparatus.

An advantage of the invention is to eliminate the need for ejection boosters as part of the machine's ejection mechanism, thereby greatly simplifying the machine construction, particularly in the case of Index machines, and consequently reducing their cost.

Advantageous features according the present invention include: 1. Using an active material element to generate a force to cause a separation between a molded part and a mold core in an injection molding apparatus; 2. Providing a force to actuate an active material element to lift a molded part from a core in a molding apparatus by a closed loop controlled force generator; 3. Removing a force urging a core away from a core plate in a molding apparatus, thereby removing the core from within a molded part.

While the present invention provides distinct advantages for injection-molded PET plastic preforms generally having circular cross-sectional shapes perpendicular to the preform axis, those skilled in the art will realize the invention is equally applicable to other molded products, possibly with non-circular cross-sectional shapes, such as, pails, paint cans, tote boxes, and other similar products. All such molded products come within the scope of the appended claims.

The individual components shown in outline or designated by blocks in the attached Drawings are all well-known in the injection molding arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

All U.S. and foreign patent documents (including the applications discussed in paragraph [0017]) discussed above are hereby incorporated by reference into the Detailed Description of the Preferred Embodiment.

1. Apparatus for separating a molded article from a mold portion, comprising:
an active material actuator disposed adjacent the mold portion and configured to change dimension when an electrical signal is applied thereto; and
transmission structure configured to provide, in use, the electrical signal to said active material actuator to cause the molded article to separate from the mold portion.

2. Apparatus according to claim 1, wherein said active material actuator is configured to be disposed between the mold portion and the molded article.

3. Apparatus according to claim 1, wherein said active material actuator comprises a piezo-electric element.

4. Apparatus according to claim 2, wherein said piezo-electric element comprises a piezoceramic device.

5. Apparatus according to claim 1, wherein the mold portion comprises a core plate, and wherein said active material actuator comprises an ejector ring.

6. Apparatus according to claim 1, further comprising an active material sensor configured to detect relative movement between the molded article and the mold portion, and further comprising control structure to receive in use, an output from said active material sensor and to provide the electrical signal to said active material actuator by closed-loop control.

7. Ejecting structure for ejecting a molded article from a core of an injection mold having a core and a core plate, comprising:
an active material actuator configured to be disposed between the core and the core plate, and configured to generate a force between the core and the core plate in response to actuation signals;
wiring structure coupled to said active material actuator and configured to carry said actuation signals.

8. Apparatus according to claim 7, further comprising biasing structure configured to bias the core away from a mold cavity, and wherein when said actuation signals are interrupted, said active material actuator stops generating said force between said core and said core plate, causing the biasing structure to cause the core to retract from the mold cavity causing the molded article to separate from the mold cavity.

9. Apparatus according to claim 7, wherein said active material actuator is configured to be disposed in an annular groove in at least one of the core and the core plate.

10. Apparatus according to claim 7, further comprising an active material sensor configured to be disposed between the core and the core plate.

11. Apparatus according to claim 10, further comprising a processor configured to receive sense signals generated by said active material sensor and to generate an actuation force signal.

12. Apparatus according to claim 10, wherein said active material actuator is disposed adjacent said active material sensor, and wherein said active material sensor is configured to sense a change in dimension of said active material actuator which corresponds to a change in distance between the core and the core plate.

13. Apparatus according to claim 7, further comprising a plurality of active material actuators configured to be disposed at different locations between the core and the core plate.

14. Apparatus according to claim 13, further comprising a plurality of active material sensors configured to be disposed at different locations between the core and the core plate, and wherein the injection molding machine includes a plurality of cores, and wherein at least one active material sensor and at least one active material actuator is configured to be disposed adjacent each core.

15. Apparatus according to claim 14, further comprising control structure configured to in use, (i) receive sense signals from said plurality of active material sensors, and (ii) transmit actuator signals to said plurality of active material actuators.

16. Apparatus according to claim 7, wherein said active material actuator comprises a piezoceramic element.

17. An injection molding machine for molding a molded article between a first mold half and a second mold half, comprising:
a piezo-electric actuator configured to be disposed between the first mold half and the second mold half of the injection molding machine, and configured to generate an expansive force between the first mold half and the molded article in response to a corresponding actuation signal; and
transmission structure configured in use, to transmit the actuation signal to said piezo-electric actuator.

18. A molding machine according to claim 17, further comprising a piezo-electric sensor configured to be disposed between the first mold half and the second mold half, and configured to generating a sense signal corresponding to a force between the first mold half and the molded article, and wherein said transmission structure is configured in use, to receive the sense signal from said piezo-electric sensor.

19. A molding machine according to claim 18, further comprising a plurality of piezo-electric sensors and a plurality of piezo-electric actuators, each configured to be disposed between the first mold half and the second mold half.

20. A molding machine according to claim 20, further comprising control structure configured to provide in use, closed-loop control between the plurality of piezo-electric sensors and the plurality of piezo-electric actuators.

21. A method for ejecting a molded part from a core half of a mold, comprising the steps of:
determining a force actuation signal to control a dimension between the molded part and the core;
transmitting the force actuation signal to a piezo-electric actuator disposed between the molded part and the core; and
using the piezo-electric actuator to generate a corresponding expansion force between the molded part and the core in response to the actuation signal, to cause the molded part to separate from the core.

22. A method according to claim 21, further comprising forcing a compressed fluid between the molded part and said core after the molded part separates from the core.

23. A method according to claim 21, further comprising disposing a plurality of piezo-ceramic actuators between the molded part and the core half.

24. A method according to claim 23, further comprising providing a stripper ring between said piezo-ceramic actuator and said molded part.

25. A method of separating a mold core half from a molded object, comprising the steps of:
transmitting an actuation signal to said active material element during molding of said molded object, thereby causing said element to expand, forcing said mold core half apart from said mold core plate;
conducting a molding operation and cooling said molded object;
ceasing transmission of said actuation signal to said active material element, thereby causing said element to contract, retracting said mold core half toward said mold core plate and withdrawing said mold core half from within said molded object.

26. An injection mold having automatic ejection structure for separating a molded part from an injection mold core, comprising:
a core plate;
a core half;
a cavity half; and
an active material actuator disposed within one or both of said core and said core plate, said active material actuator being connected to control means for providing actuation signals to said active material actuator, wherein removal of said actuation signals in use, from said active material actuator causes said core to retract from within said molded part.

27. An injection mold having automatic ejection structure for removing a molded object from an injection mold core half, comprising:
a core plate;
a core half;
a stripper ring; and
a piezoelectric actuator disposed between said core and said stripper ring, said piezoelectric actuator being connected to a controller providing actuation signals to said piezoelectric actuator, wherein application of said actuation signals in use, causes said piezoelectric actuator to expand.
